(19) United States
(12) Patent Application Publication
(10) Pub. No.: US 2024/0314718 A1
(43) Pub. Date: Sep. 19, 2024

(54) NEW METHOD FOR EXTERNAL PARAMETER PROVISIONING FOR AN AF SESSION

(71) Applicant: TELEFONAKTIEBOLAGET LM ERICSSON (PUBL), Stockholm (SE)

(72) Inventors: Ping Chen, Shanghai (CN); Jingrui Tao, Guangdong (CN); Emiliano Merino Vazquez, Leganés (ES)

(21) Appl. No.: 18/278,722

(22) PCT Filed: Jan. 21, 2022
(86) PCT No.: PCT/CN2022/073185

§ 371 Date: Aug. 24, 2023

(30) Foreign Application Priority Data
Feb. 26, 2021 (WO) PCT/CN2021/078071

(51) Int. Cl. H04W 60/04; H04W 8/08

(52) U.S. Cl. CPC H04W 60/04; H04W 8/08

(57) ABSTRACT

Embodiments of the present disclosure provide external parameters for an Application Function (AF) session in a more efficient and dynamic manner. A method of operation of the AF comprises transmitting a request to a Network Exposure Function (NEF). Herein, the request comprises information indicating one or more User Equipments (UEs). Herein, the one or more UEs may include a UE that has not established a Protocol Data Unit (PDU) session yet. The information indicating the one or more UEs includes a UE ID for a specific UE, a group UE ID for multiple UEs, or a UE indication indicating any UE, and optionally includes one or more conditions defining geographic zones and/or time windows.

### TECHNICAL FIELD

The present disclosure relates to providing external parameters for an Application Function (AF) session in a more efficient and dynamic manner.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

FIG. 1 depicts a Fifth Generation (5G) reference architecture as defined by 3GPP. There are several architectural aspects are relevant to the present application: Application Function (AF), Network Exposure Function (NEF), Policy Control Function (PCF), Unified Data Repository (UDR), and etc. Herein, the AF interacts with the 3GPP Core Network, and specifically allows external parties to use exposure Application Programming Interfaces (APIs) offered by a network operator. The NEF supports different functionality and specifically supports different exposure APIs. The UDR supports storage and retrieval of structured data for exposure and application data including AF request Quality of Service (QOS) information. The PCF supports a unified policy framework to govern network behavior, provides policy rules to control plane function(s) to enforce them and accesses subscription information relevant for policy decisions in the UDR.

Currently, a procedure of providing external parameters for an AF session as defined in the 3GPP, such as setting up an AF session with required QoS, setting a chargeable party at AF session setup, or the like, can only be applied to one ongoing Protocol Data Unit (PDU) session associated with one User Equipment (UE). It is not possible to determine/change the QoS of any UE(s), which have not setup the PDU session yet, or multiple UEs. Similarly, it is not possible to determine/change the charge party of any UE(s), which have not setup the PDU session yet, or multiple UEs. This means that the AF can only instruct the 5GC network with an IP flow (based on an IP address allocated to the UE(s) which is sending traffic to the AF).

In addition, it will be cumbersome for a 3^{rd} party application to request the change of QoS for multiple UEs and also impossible to change QoS for any UE that has not yet setup a PDU session but under certain conditions (e.g. location and time duration). However, these features may be very useful for edge computing type of scenarios (e.g., scheduled sports events).

### SUMMARY

Certain aspects of the present disclosure and their embodiments may provide solutions to the aforementioned or other challenges. Methods and apparatuses are disclosed herein, in which an Application Function (AF) may influence external parameter(s) (e.g., Quality of Service (QOS) and/or a charge party) for any User Equipment (UE) that has not setup a Protocol Data Unit (PDU) session yet or a group of UEs in a dynamic manner, with optionally considering other conditions (location, time period, etc.).

There are, proposed herein, various embodiments which address one or more of the issues disclosed herein. In one embodiment, a method of operation of an Application Function (AF) comprises transmitting a request to a Network Exposure Function (NEF) and receiving, from the NEF, an NEF response indicating whether the request is granted or not. Herein, the request comprises information indicating at least one UE that has not established a PDU session yet.

In one embodiment, the information indicating the at least one UE comprises a UE identity (UE ID) of a specific UE of the at least one UE.

In one embodiment, the UE ID is a Generic Public Subscription Identifier (GPSI) or a UE IP address.

In one embodiment, the information indicating the at least one UE comprises a UE indication, which identifies whether the request applies to any UE of the at least one UE.

In one embodiment, a method of operation of an AF comprises transmitting a request to an NEF and receiving, from the NEF, an NEF response indicating whether the request is granted or not. Herein, the request comprises information indicating a plurality of UEs.

In one embodiment, the plurality of UEs comprises at least one UE that has not established a PDU session yet.

In one embodiment, the information indicating the plurality of UEs comprises a list of UE IDs of the plurality of UEs, a UE group ID of the plurality of UEs, or a UE indication that identifies whether the request applies to any UE of the plurality of UEs.

In one embodiment, the request further comprises one or more conditions to be satisfied by the plurality of UEs.

In one embodiment, the one or more conditions define one or more geographic zones, one or more time windows, or both one or more geographic zones and one or more time windows.

In one embodiment, the request is a request to set up an AF session with required QoS, or a request to set a chargeable party at an AF session set-up. The NEF response is a response to set up an AF session with required QoS, or a response to set a chargeable party at an AF session set-up, respectively.

Corresponding embodiments of an AF are also disclosed. In one embodiment, the AF is adapted to transmit a request to an NEF and receive, from the NEF, an NEF response indicating whether the request is granted or not. Herein, the request comprises information indicating at least one UE that has not established a PDU session yet. The information indicating the at least one UE comprises a UE ID of a specific UE of the at least one UE, or comprises a UE indication, which identifies whether the request applies to any UE of the at least one UE. In another embodiment, the request comprises information indicating a plurality of UEs. The information indicating the plurality of UEs comprises a list of UE IDs of the plurality of UEs, a UE group ID of the plurality of UEs, or a UE indication that identifies whether the request applies to any UE of the plurality of UEs.

In one embodiment, a network node that implements an AF comprises a network interface and processing circuitry associated with the network interface. The processing circuitry is configured to cause the network node to transmit a request to an NEF and receive, from the NEF, an NEF response indicating whether the request is granted or not. Herein, the request comprises information indicating at least one UE that has not established a PDU session yet. The information indicating the at least one UE comprises a UE ID of a specific UE of the at least one UE, or comprises a UE indication, which identifies whether the request applies to any UE of the at least one UE. In another embodiment, the request comprises information indicating a plurality of UEs. The information indicating the plurality of UEs comprises a list of UE IDs of the plurality of UEs, a UE group ID of the plurality of UEs, or a UE indication that identifies whether the request applies to any UE of the plurality of UEs.

In one embodiment, a method of operation of an NEF comprises receiving a request from an AF and transmitting, to the AF, an NEF response indicating whether the request is granted or not. Herein, the request comprises information indicating at least one UE that has not established a PDU session yet, or comprises information indicating a plurality of UEs.

In one embodiment, the method of operation of the NEF further comprises transmitting a data update request to a Unified Data Repository (UDR) for storage, and receiving, from the UDR, a UDR response indicating that the data update request is stored in the UDR. Herein, the data update request comprises information associated with the information indicating the at least one UE that has not established a PDU session yet, or associated with the information indicating the plurality of UEs.

In one embodiment, the request further comprises one or more conditions to be satisfied by the at least one UE or the plurality of UEs. The data update request further comprises information associated with the one or more conditions.

In one embodiment, the data update request further comprises QoS data or sponsor data.

In one embodiment, the method of operation of the NEF further comprises authorizing the request from the AF.

Corresponding embodiments of an NEF are also disclosed. In one embodiment, the NEF is adapted to receive a request from an AF and transmit, to the AF, an NEF response indicating whether the request is granted or not. Herein, the request comprises information indicating at least one UE that has not established a PDU session yet, or comprises information indicating a plurality of UEs.

In one embodiment, a network node that implements an NEF comprises a network interface and processing circuitry associated with the network interface. The processing circuitry is configured to cause the network node to receive a request from an AF and transmit, to the AF, an NEF response indicating whether the request is granted or not. Herein, the request comprises information indicating at least one UE that has not established a PDU session yet. The information indicating the at least one UE comprises a UE ID of a specific UE of the at least one UE, or comprises a UE indication, which identifies whether the request applies to any UE of the at least one UE. In another embodiment, the request comprises information indicating a plurality of UEs. The information indicating the plurality of UEs comprises a list of UE IDs of the plurality of UEs, a UE group ID of the plurality of UEs, or a UE indication that identifies whether the request applies to any UE of the plurality of UEs.

In one embodiment, the processing circuitry is further configured to cause the network node to transmit a data update request to a UDR for storage, and receive from the UDR, a UDR response indicating that the data update request is stored in the UDR. Herein, the data update request comprises information associated with the information indicating the at least one UE that has not established a PDU session yet, or associated with the information indicating the plurality of UEs.

In one embodiment, a method of operation of a UDR comprises receiving a data update request from an NEF for storage and transmitting to the NEF a UDR response indicating that the data update request is stored in the UDR. Herein, the data update request comprises information associated with information indicating at least one UE that has not established a PDU session yet, or associated with information indicating a plurality of UEs.

In one embodiment, the method of operation of the UDR further comprises transmitting, to a policy control function (PCF), a notification corresponding to the data update request, and receiving, from the PCF, a notification response indicating that the PCF successfully receives the notification. Herein, the notification comprises information associated with the information indicating the at least one UE that has not established a PDU session yet, or associated with the information indicating the plurality of UEs.

In one embodiment, the data update request further comprises information associated with one or more conditions to be satisfied by the at least one UE or the plurality of UEs. The notification further comprises information associated with the one or more conditions to be satisfied by the at least one UE or the plurality of UEs, respectively.

In one embodiment, the data update request further comprises QoS data or sponsor data, and the notification further comprises information associated with the QoS data or the sponsor data, respectively.

In one embodiment, the method of operation of the UDR, before transmitting the notification, further comprises receiving a subscription from the PCF for subscribing the notification corresponding to the data update request, or receiving a query from the PCF, during UE registration, for requesting the notification corresponding to the data update request.

Corresponding embodiments of a UDR are also disclosed. In one embodiment, the UDR is adapted to receive a data update request from an NEF for storage and transmit, to the NEF, a UDR response indicating that the data update request is stored in the UDR. Herein, the data update request comprises information associated with information indicating at least one UE that has not established a PDU session yet, or associated with information indicating a plurality of UEs.

In one embodiment, a network node that implements a UDR comprises a network interface and processing circuitry associated with the network interface. The processing circuitry is configured to cause the network node to receive a data update request from an NEF for storage and transmit, to the NEF, a UDR response indicating that the data update request is stored in the UDR. Herein, the data update request comprises information associated with information indicating at least one UE that has not established a PDU session yet. The information indicating the at least one UE comprises a UE ID of a specific UE of the at least one UE, or comprises a UE indication, which indicates any UE of the at least one UE. In another embodiment, the data update request comprises information associated with information indicating a plurality of UEs. The information indicating the plurality of UEs comprises a list of UE IDs of the plurality of UEs, a UE group ID of the plurality of UEs, or a UE indication that indicates any UE of the plurality of UEs.

In one embodiment, the processing circuitry is further configured to cause the network node to transmit, to a PCF, a notification corresponding to the data update request, and receive, from the PCF, a notification response indicating that the PCF successfully receives the notification. Herein, the notification comprises information associated with the information indicating the at least one UE that has not established a PDU session yet, or associated with the information indicating the plurality of UEs.

In one embodiment, the processing circuitry is further configured to cause the network node to receive a subscription from the PCF for subscribing the notification corresponding to the data update request, or receive a query from the PCF, during UE registration, for requesting the notification corresponding to the data update request.

In one embodiment, a method of operation of a PCF comprises receiving, from a UDR, a notification corresponding to a data update request, and transmitting, to the UDR, a notification response indicating that the PCF successfully receives the notification. Herein, the notification comprises information associated with information indicating the at least one UE that has not established a PDU session yet, or associated with information indicating the plurality of UEs.

In one embodiment, the method of operation of the PCF, before receiving the notification, further comprises transmitting a subscription to the UDR for subscribing the notification corresponding to the data update request, or transmitting a query to the UDR, during UE registration, for requesting the notification corresponding to the data update request.

In one embodiment, the method of operation of the PCF further comprises transmitting, to a session management function (SMF), a subscription for subscribing a location notification that notifies when the at least one UE/the plurality UEs enters or exits the one or more geographic zones.

In one embodiment, the method of operation of the PCF further comprises receiving, from the SMF, the location notification when the at least one UE/the plurality UEs enters or exits the one or more geographic zones.

In one embodiment, the method of operation of the PCF further comprises making a policy decision based on the location of the at least one UE/the plurality UEs within or without the one or more geographic zones, and/or based on a current time within or without the one or more time windows.

In one embodiment, the method of operation of the PCF further comprises, based on the policy decision, transmitting a policy update request including updated policy and charging control (PCC) rules to the SMF and receiving, from the SMF, an acknowledge response acknowledging the policy update request. Herein, the updated PCC rules are utilized for at least one PDU session associated with the at least one UE, or utilized for PDU sessions associated with the plurality UEs.

In one embodiment, the updated PCC rules include QoS parameters according to the QoS data retrieved from the UDR or includes sponsor parameters according to the sponsor data retrieved from the UDR.

Corresponding embodiments of a PCF are also disclosed. In one embodiment, the PCF is adapted to receive, from a UDR, a notification corresponding to a data update request, and transmit, to the UDR, a notification response indicating that the PCF successfully receives the notification. Herein, the notification comprises information associated with information indicating the at least one UE that has not established a PDU session yet, or associated with information indicating the plurality of UEs.

In one embodiment, a network node that implements a PCF comprises a network interface and processing circuitry associated with the network interface. The processing circuitry is configured to cause the network node to receive, from a UDR, a notification corresponding to a data update request, and transmit, to the UDR, a notification response indicating that the PCF successfully receives the notification. Herein, the notification comprises information associated with information indicating at least one UE that has not established a PDU session yet. The information indicating the at least one UE comprises a UE ID of a specific UE of the at least one UE, or comprises a UE indication, which indicates any UE of the at least one UE. In another embodiment, the notification comprises information associated with information indicating a plurality of UEs. The information indicating the plurality of UEs comprises a list of UE IDs of the plurality of UEs, a UE group ID of the plurality of UEs, or a UE indication that indicates any UE of the plurality of UEs.

In one embodiment, the processing circuitry is further configured to cause the network node to transmit a subscription to the UDR for subscribing the notification corresponding to the data update request, or transmit a query to the UDR, during UE registration, for requesting the notification corresponding to the data update request.

In one embodiment, the processing circuitry is further configured to cause the network node to transmit, to an SMF, a subscription for subscribing a location notification that notifies when the at least one UE/the plurality UEs enters or exits the one or more geographic zones.

In one embodiment, the processing circuitry is further configured to cause the network node to receive, from the SMF, the location notification when the at least one UE/the plurality UEs enters or exits the one or more geographic zones.

In one embodiment, the processing circuitry is further configured to cause the network node to make a policy decision based on the location of the at least one UE/the plurality UEs within or without the one or more geographic zones, and/or based on a current time within or without the one or more time windows.

In one embodiment, the processing circuitry is further configured to cause the network node to, based on the policy decision, transmit a policy update request including updated PCC rules to the SMF and receive, from the SMF, an acknowledge response acknowledging the policy update request. Herein, the updated PCC rules are utilized for at least one PDU session associated with the at least one UE, or utilized for PDU sessions associated with the plurality UEs.

Certain embodiments may provide one or more of the following technical advantage(s). For example, certain embodiments allow the AF to apply a certain QoS/certain charge party to the UE(s) with the intended identity and optionally matching the conditions described above. It does not need to wait for the UE(s) to establish a PDU session. Instead, it can program the network so that as soon as the UE attaches the 5GC network, the requested QoS/chargeable party is applied.

In addition, certain embodiments allow external 3^{rd} parties to request the network operator to change QoS requirements for one or more UEs in a more efficient and dynamic manner. For instance, with a single request from a 3^{rd} party, the AF can indicate the QoS/chargeable party to be applied to a large number of UEs.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a Fifth Generation (5G) reference architecture as defined by Third Generation Partnership Project (3GPP).

FIG. 2 illustrates one example of a cellular communications system according to some embodiments of the present disclosure.

FIGS. 3 and 4 illustrate example embodiments in which the cellular communication system of FIG. 2 is a 5G System (5GS).

FIGS. 5A and 5B illustrate operations of Network Functions (NFs) within the cellular communication system of FIG. 2 in accordance with some embodiments of the present disclosure.

FIG. 6 illustrates operations of an Application Function (AF) in accordance with some embodiments of the present disclosure.

FIG. 7 illustrates operations of a Network Exposure Function (NEF) in accordance with some embodiments of the present disclosure.

FIG. 8 illustrates operations of a Unified Data Repository (UDR) in accordance with some embodiments of the present disclosure.

FIG. 9 illustrates operations of a Policy Control Function (PCF) in accordance with some embodiments of the present disclosure.

FIG. 10 is a schematic block diagram of a network node according to some embodiments of the present disclosure.

FIG. 11 is a schematic block diagram that illustrates a virtualized embodiment of the network node of FIG. 10 according to some embodiments of the present disclosure.

FIG. 12 is a schematic block diagram of the network node of FIG. 10 according to some other embodiments of the present disclosure.

FIG. 13 illustrates a telecommunication network connected via an intermediate network to a host computer in accordance with some embodiments of the present disclosure.

FIG. 14 is a generalized block diagram of a host computer communicating via a base station with a UE over a partially wireless connection in accordance with some embodiments of the present disclosure.

FIG. 15 is a flowchart illustrating a method implemented in a communication system in accordance with one embodiment of the present disclosure.

FIG. 16 is a flowchart illustrating a method implemented in a communication system in accordance with one embodiment of the present disclosure.

FIG. 17 is a flowchart illustrating a method implemented in a communication system in accordance with one embodiment of the present disclosure.

FIG. 18 is a flowchart illustrating a method implemented in a communication system in accordance with one embodiment of the present disclosure.

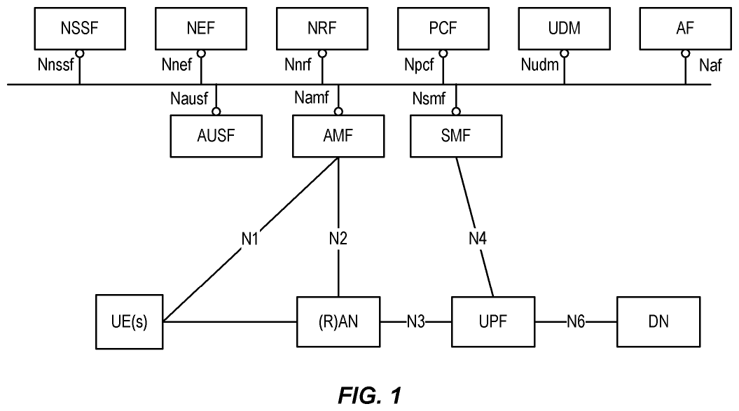

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

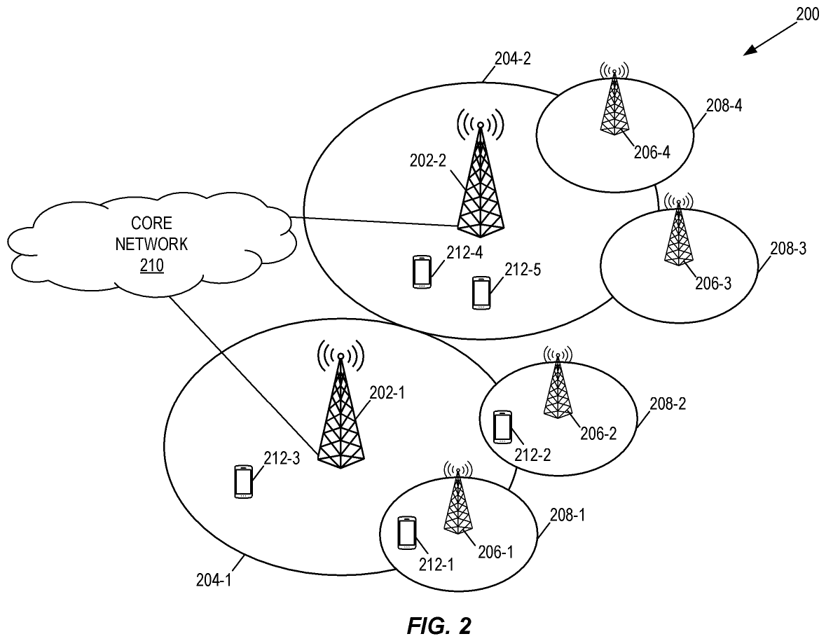

FIG. 2 illustrates one example of a cellular communications system 200 in which embodiments of the present disclosure may be implemented. In the embodiments described herein, the cellular communications system 200 is a 5G system (5GS) including a Next Generation RAN (NG-RAN) and a 5G Core (5GC) or a 4G system (4GS), such as LTE. In this example, the RAN includes base stations 202-1 and 202-2, which in the 5GS include NR base stations (gNBs) and optionally next generation eNBs (ng-eNBs) (e.g., LTE RAN nodes connected to the 5GC) and in the 4GS include eNBs, controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or Remote Radio Heads (RRHs), or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5G System (5GS) is referred to as the 5GC. The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs, but the present disclosure is not limited thereto.

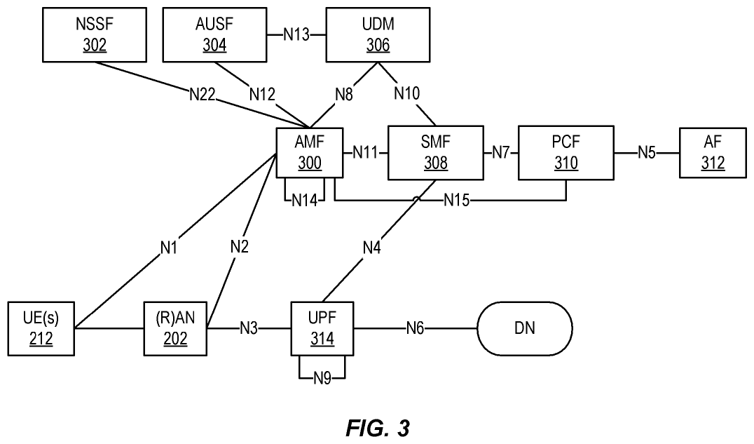

FIG. 3 illustrates a wireless communication system represented as a 5G network architecture composed of core Network Functions (NFs), where interaction between any two NFs is represented by a point-to-point reference point/interface. FIG. 3 can be viewed as one particular implementation of the system 200 of FIG. 2.

Seen from the access side the 5G network architecture shown in FIG. 3 comprises a plurality of UEs 212 connected to either a RAN 202 or an Access Network (AN) as well as an AMF 300. Typically, the R(AN) 202 comprises base stations, e.g., such as eNBs or gNBs or similar. Seen from the core network side, the 5GC NFs shown in FIG. 3 include a NSSF 302, an AUSF 304, a UDM 306, the AMF 300, a SMF 308, a PCF 310, and an Application Function (AF) 312.

Reference point representations of the 5G network architecture are used to develop detailed call flows in the normative standardization. The N1 reference point is defined to carry signaling between the UE 212 and AMF 300. The reference points for connecting between the AN 202 and AMF 300 and between the AN 202 and UPF 314 are defined as N2 and N3, respectively. There is a reference point, N11, between the AMF 300 and SMF 308, which implies that the SMF 308 is at least partly controlled by the AMF 300. N4 is used by the SMF 308 and UPF 314 so that the UPF 314 can be set using the control signal generated by the SMF 308, and the UPF 314 can report its state to the SMF 308. N9 is the reference point for the connection between different UPFs 314, and N14 is the reference point connecting between different AMFs 300, respectively. N15 and N7 are defined since the PCF 310 applies policy to the AMF 300 and SMF 308, respectively. N12 is required for the AMF 300 to perform authentication of the UE 212. N8 and N10 are defined because the subscription data of the UE 212 is required for the AMF 300 and SMF 308.

The 5GC network aims at separating UP and CP. The UP carries user traffic while the CP carries signaling in the network. In FIG. 3, the UPF 314 is in the UP and all other NFs, i.e., the AMF 300, SMF 308, PCF 310, AF 312, NSSF 302, AUSF 304, and UDM 306, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 300 and SMF 308 are independent functions in the CP. Separated AMF 300 and SMF 308 allow independent evolution and scaling. Other CP functions like the PCF 310 and AUSF 304 can be separated as shown in FIG. 3. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

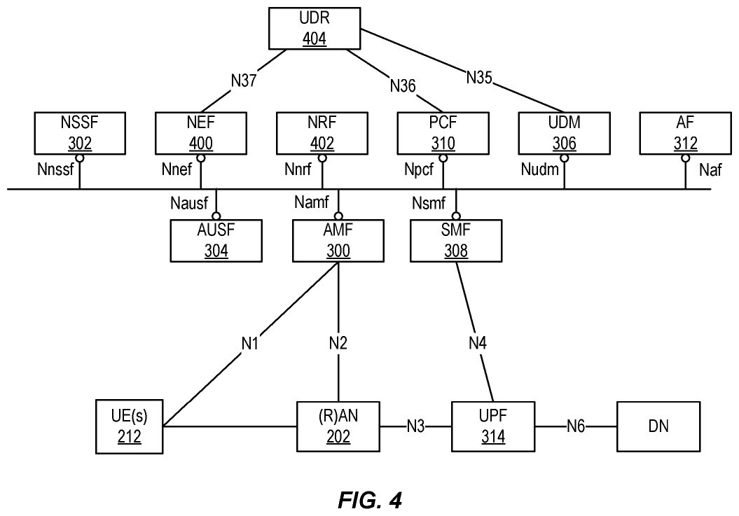

FIG. 4 illustrates a 5G network architecture using service-based interfaces between the NFs in the CP, instead of the point-to-point reference points/interfaces used in the 5G network architecture of FIG. 3. However, the NFs described above with reference to FIG. 3 correspond to the NFs shown in FIG. 4. The service(s) etc. that a NF provides to other authorized NFs can be exposed to the authorized NFs through the service-based interface. In FIG. 4 the service based interfaces are indicated by the letter “N” followed by the name of the NF, e.g. Namf for the service based interface of the AMF 300 and Nsmf for the service based interface of the SMF 308, etc. The NEF 400, the NRF 402, and the UDR 404 in FIG. 4 are not shown in FIG. 3 discussed above. However, it should be clarified that all NFs depicted in FIG. 3 can interact with the NEF 400 and the NRF 402 of FIG. 4 as necessary, though not explicitly indicated in FIG. 3.

Some properties of the NFs shown in FIGS. 3 and 4 may be described in the following manner. The AMF 300 provides UE-based authentication, authorization, mobility management, etc. A UE 212 even using multiple access technologies is basically connected to a single AMF 300 because the AMF 300 is independent of the access technologies. The SMF 308 is responsible for session management and allocates Internet Protocol (IP) addresses to UEs. It also selects and controls the UPF 314 for data transfer. If a UE 212 has multiple sessions, different SMFs 308 may be allocated to each session to manage them individually and possibly provide different functionalities per session. The AF 312 provides information on the packet flow to the PCF 310 responsible for policy control in order to support QoS. Based on the information, the PCF 310 determines policies about mobility and session management to make the AMF 300 and SMF 308 operate properly. The AUSF 304 supports authentication function for UEs or similar and thus stores data for authentication of UEs or similar while the UDM 306 stores subscription data of the UE 212. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

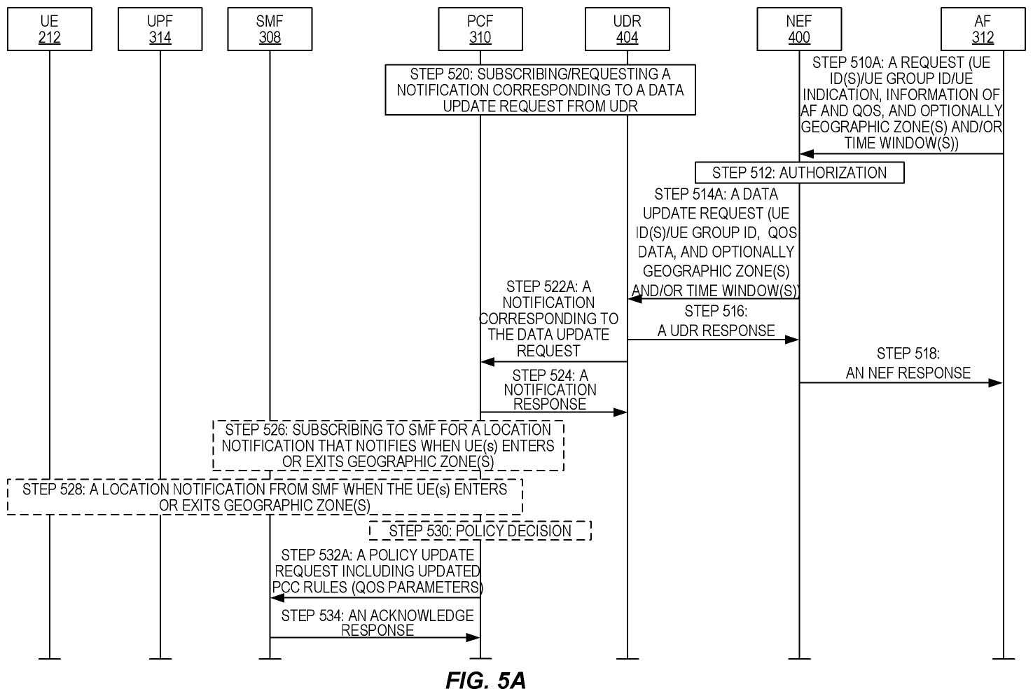

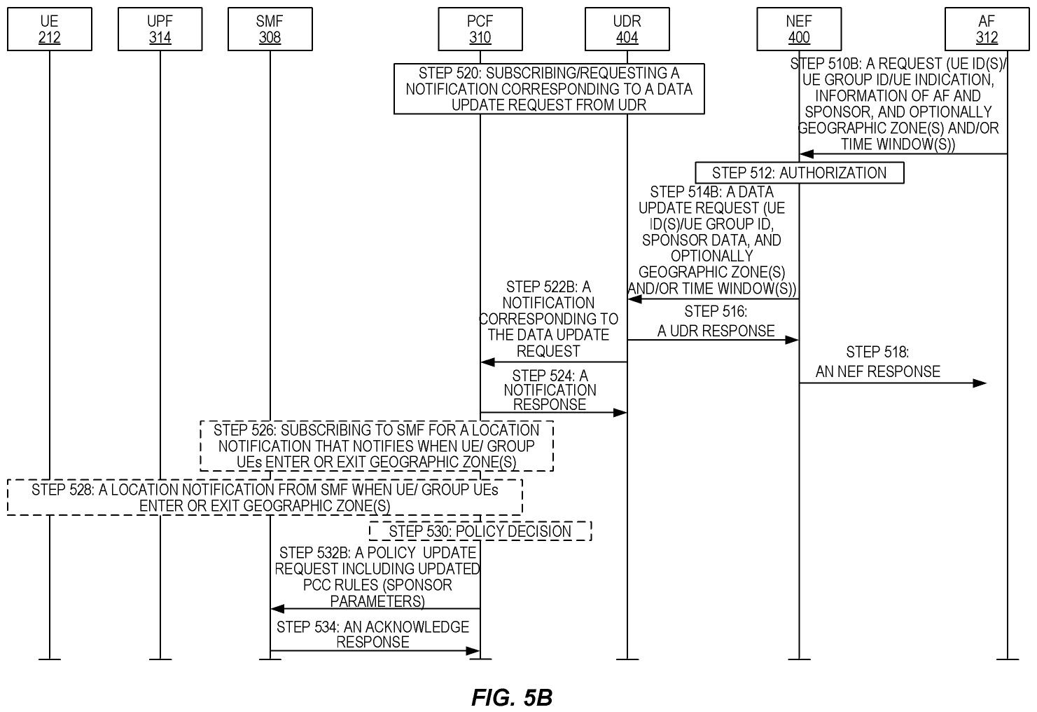

FIGS. 5A and 5B illustrate operations of NFs within the cellular communication system 200 in accordance with some embodiments of the present disclosure. FIG. 5A shows a sequence diagram for setting up AF session with required QoS, with detailed steps below:
Step 510A) AF 312 decides to transmit a request with QoS requirement to a Mobile Network Operator (MNO) via an enhanced NEF API (i.e. Nnef_AFsessionWithQoS) or a new API, including the following parameters:
   An identity (e.g. Generic Public Subscription Identifier (GPSI) or UE IP address, like “ipv4Addr”/“ipv6Addr”) for one specific UE that has not established a protocol data unit (PDU) session yet, an identity for a group of UEs (e.g., externalGroupId), a list identities for a group of UEs, or a UE indication, which identifies whether the request applies to any UE, i.e. all UEs, (e.g., anyUeInd). The attribute of the UE indication will be set to “true” if applicable for any UE, otherwise, set to “false”. Herein, these UE identity/indication information are used to indicate target UE(s).
   (Optional) Conditions that the target UE(s) need to meet:
      Location indication: indicating one or more geographic areas. The AF request is applied to the traffic of UE(s) located within the one or more geographic areas; and
      Time indication: indicating one or more time windows. The AF request is applied to the traffic of UE(s) during the one or more time windows.
   AF-ID/Provider-ID: indicates the AF identifier (e.g., identifies a police department) and/or Provider Identifier (e.g., National government for regulatory services).
   IP Flows/AppId: identify or description of the application flows. This may include the 3-tuple or appid to identify the application.
   QOS Reference: the reference provided by 3^{rd} party application mapping to QoS parameters by the NEF/PCF within the MNO.
   (Optional) DNN/S-NSSAI: the target DNN/S-NSSAI to apply for the specific Qos flow.
   (Optional) usageThreshold: Time period and/or traffic volume in which the QoS is to be applied.
   (Optional) qosMonInfo: QOS Monitoring information.
Step 512) The NEF 400 authorizes the request from the AF 312 and also authorizes the AF 312 to allow to use the service. The NEF 400 may also translates the external identities to internal identities via standard UDM identity translation service, e.g., GPSI=>SUPI, external Group Identity=>internal Group Identity, and also mapping the geographic Zone(s) to network tracking area identity for example.
Step 514A) The NEF 400 transmits a data update request to the UDR 404 for storage. The data update request includes information associated with identity/indication of UE(s) and optional conditions described in Step 510A. The data update request will also include QoS data, such as the QOS Reference, the IP Flows, the DNN/S-NSSAI, the usageThreshold, and/or the qosMonInfo described in Step 510A. The data update request may be transmitted via an enhanced Nudr_DataRepository Service.
Step 516) The UDR 404 transmits to NEF 400 a UDR response indicating that the data update information is stored in the UDR 404.
Step 518) The NEF 400 transmits to the AF 312, an NEF response indicating whether the request described in Step 510A is granted or not.
Step 520) The PCF 310 transmits a subscription to the UDR 404 for subscribing a notification corresponding to the data update request. The subscription may be transmitted via a Nudr_DM service. Alternatively, the PCF 310 transmits a query to the UDR 404, during UE registration, for requesting the notification corresponding to the data update request.
Step 522A) The UDR 404 transmits to the PCF 310 a notification corresponding to the data update request, wherein the notification comprises the information associated with identity/indication of UE(s), QoS data, and optional conditions described in Step 510A.
Step 518) The PCF 310 transmits to the AF 312, a notification response indicating that the PCF successfully receives the notification.
Step 526) The PCF 310 may transmit to the SMF 308 a subscription for subscribing the location notification (if available) that notifies when the target UE(s) 212 enters or exits the one or more geographic zones.
Step 528) The PCF 310 may receive from the SMF 308, the location notification when the target UE(s) 212 enters or exits the one or more geographic zones.
Step 530) The PCF 310 may make a policy decision based on a location of the target UE(s) within or without the one or more geographic zones, and/or based on a current time within or without the one or more time windows.
Step 532A) based on the policy decision, the PCF 310 transmits a policy update request to the SMF 308, the policy update request including updated policy and charging control (PCC) rules, which are utilized for a PDU session associated with the target UE(s). The updated PCC rules include QoS parameters according to the QoS data retrieved from the UDR 404.
Step 534) the PCF 310 receives from the SMF 308 an acknowledge response acknowledging the policy update request.

After the policy is not validated, e.g., when the UE(s) leave the one or more geographic zones or the one or more window are expired, the PCF 310 will restore the PCC rules back to normal.

Similarly, FIG. 5B shows a sequence diagram for setting a chargeable party at AF session, with detailed steps below:
Step 510B) AF 312 decides to transmit a request with chargeable party requirement to an MNO via an enhanced NEF API (i.e. Nnef_ChargeableParty API) or a new API, including the following parameters:
   An identity (e.g. Generic Public Subscription Identifier (GPSI) or UE IP address, like “ipv4Addr”/“ipv6Addr”) for one specific UE that has not established a protocol data unit (PDU) session yet, an identity for a group of UEs (e.g., externalGroupId), a list identities for a group of UEs, or a UE indication, which identifies whether the request applies to any UE, i.e. all UEs, (e.g., anyUeInd). The attribute of the UE indication will be set to “true” if applicable for any UE, otherwise, set to “false”. Herein, these UE identity/indication information are used to indicate target UE(s).
   (Optional) Conditions that the target UE(s) needs to meet:
      Location indication: indicating one or more geographic areas. The AF request is applied to the traffic of UE(s) located within the one or more geographic areas; and
      Time indication: indicating one or more time windows. The AF request is applied to the traffic of UE(s) during the one or more time windows.
   AF-ID/Provider-ID: indicates the AF identifier (e.g., identifies a police department) and/or Provider Identifier (e.g., National government for regulatory services).
   IP Flows/AppId: identify or description of the application flows. This may include the 3-tuple or AppId to identify the application.
   Sponsor Information: Indicates a sponsor information.
   Sponsor Status: indicates whether sponsoring is started or stopped, i.e. whether the 3^{rd} party service provider is the chargeable party or not.
   (Optional) Background Data Transfer Reference ID: identifies a previously negotiated transfer policy for background data transfer.
   (Optional) usageThreshold: Time period and/or traffic volume.
Step 512) The NEF 400 authorizes the request from the AF 312 and also authorizes the AF 312 to allow to use the service. The NEF 400 may also translate the external identities to internal identities via standard UDM identity translation service, e.g., GPSI=>SUPI, external Group Identity=>internal Group Identity, and also mapping the geographic Zone(s) to network tracking areas identity for example.
Step 514B) The NEF 400 transmits a data update request to the UDR 404 for storage. The data update request includes information associated with identity/indication of UE(s) and optional conditions described in Step 510B. The data update request will also include sponsor data, such as the Sponsor Information, the Sponsor Status, the IP Flows, the Background Data Transfer Reference ID, and/or the usageThreshold described in Step 510B. The data update request may be transmitted via an enhanced Nudr_DataRepository Service.
Step 516) The UDR 404 transmits to NEF 400 a UDR response indicating that the data update information is stored in the UDR 404.
Step 518) The NEF 400 transmits to the AF 312, an NEF response indicating whether the request described in Step 510B is granted or not.
Step 520) The PCF 310 transmits a subscription to the UDR 404 for subscribing a notification corresponding to the data update request. The subscription may be transmitted via a Nudr_DM service. Alternatively, the PCF 310 transmits a query to the UDR 404, during UE registration, for requesting the notification corresponding to the data update request.
Step 522B) The UDR 404 transmits to the PCF 310 a notification corresponding to the data update request, wherein the notification comprises the information associated with identity/indication of UE(s), sponsor data, and optional conditions described in Step 510B.
Step 518) The PCF 310 transmits to the AF 312, a notification response indicating that the PCF successfully receives the notification.
Step 526) The PCF 310 may transmit to the SMF 308 a subscription for subscribing the location notification (if available) that notifies when the target UE(s) 212 enters or exits the one or more geographic zones.
Step 528) The PCF 310 may receive from the SMF 308, the location notification when the target UE(s) 212 enters or exits the one or more geographic zones.
Step 530) The PCF 310 may make a policy decision based on a location of the target UE(s) within or without the one or more geographic zones, and/or based on a current time within or without the one or more time windows.
Step 532B) based on the policy decision, the PCF 310 transmits a policy update request to the SMF 308, the policy update request including updated policy and charging control (PCC) rules, which are utilized for a PDU session associated with the target UE(s). The updated PCC rules include sponsor parameters according to the sponsor data retrieved from the UDR 404.
Step 534) the PCF 310 receives from the SMF 308 an acknowledge response acknowledging the policy update request.

After the policy is not validated, e.g., when the UE(s) leave the one or more geographic zones or the one or more window are expired, the PCF 310 will restore the PCC rules back to normal.

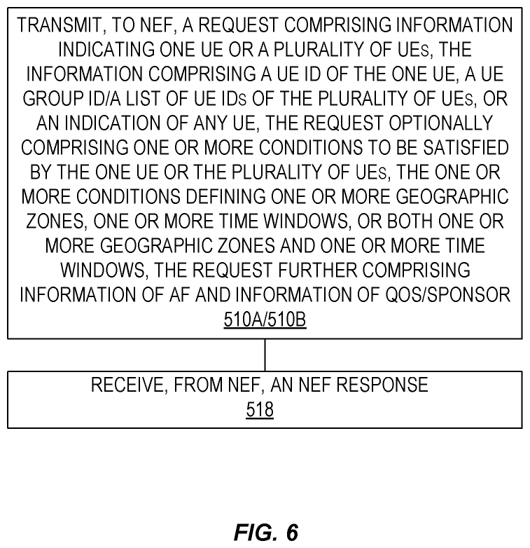

FIG. 6 is a flow chart illustrating the operation of an application function (like AF 312), in accordance with some embodiments. In step 510A/510B, the AF 312 transmits a request to an NEF (like NEF 400). In one embodiment, the request comprises information indicating at least one UE (like UE 212) that has not established a session yet. The information indicating the at least one UE may include a UE identity (e.g., GPSI or a UE IP address) for a specific UE of the at least one UE or include a UE indication (e.g., anyUeInd) that identifies whether the request applies to any UE of the at least one UE. In another embodiment, the request from the AF to the NEF comprises information indicating a plurality of UEs (like UEs 212-4˜212-5). The information indicating the plurality of UEs may include a list of UE IDs of the plurality of UEs, a UE group ID of the plurality of UEs (e.g., externalGroupId), or a UE indication (e.g., anyUeInd) that identifies whether the request applies to any UE of the plurality of UEs. In some embodiments, the plurality of UEs comprises at least one UE that has not established a PDU session yet.

Herein, the request further includes one or more conditions to be satisfied by the at least one UE/the plurality of UEs. Herein, the one or more conditions define one or more geographic zones, one or more time windows, or both one or more geographic zones and one or more time windows.

In addition, the request from the AF to the NEF may be a request to set up an AF session with required QoS, where the request may further include information (e.g., AF-ID/Provider-ID, IP Flows/AppId, QOS Reference, DNN/S-NSSAI, usageThreshold, and/or qosMonInfo) for a change/set-up of QoS. Alternatively, the request from the AF to the NEF may be a request to set a chargeable party at an AF session set-up, where the request may further include information (e.g., AF-ID/Provider-ID, IP Flows/AppId, Sponsor Information, Sponsor Status, Background Data Transfer Reference ID, and/or usageThreshold) for a change/set-up of a chargeable party.

In step 518, the AF 312 receives from the NEF 400 an NEF response indicating whether the request is granted or not.

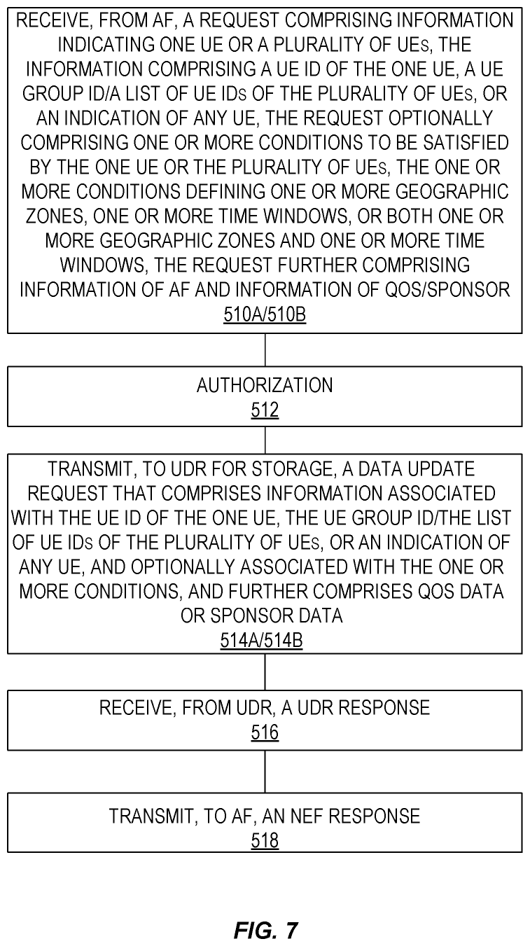

FIG. 7 is a flow chart illustrating the operation of a network exposure function (like NEF 400), in accordance with some embodiments. In step 510A/510B, the NEF 400 receives a request from an AF (like AF 312). In one embodiment, the request comprises information indicating at least one UE (like UE 212) that has not established a session yet. The information indicating the at least one UE may include a UE identity (e.g., GPSI or a UE IP address) for a specific UE of the at least one UE or include a UE indication (e.g., anyUeInd) that identifies whether the request applies to any UE of the at least one UE. In another embodiment, the request from the AF to the NEF comprises information indicating a plurality of UEs (like UEs 212-4˜212-5). The information indicating the plurality of UEs may include a list of UE IDs of the plurality of UEs, a UE group ID of the plurality of UEs (e.g., externalGroupId), or a UE indication (e.g., anyUeInd) that identifies whether the request applies to any UE of the plurality of UEs. In some embodiments, the plurality of UEs comprises at least one UE that has not established a protocol data unit, PDU, session yet.

Herein, the request further includes one or more conditions to be satisfied by the at least one UE/the plurality of UEs. Herein, the one or more conditions define one or more geographic zones, one or more time windows, or both one or more geographic zones and one or more time windows.

In addition, the request from the AF to the NEF may be a request to set up an AF session with required QoS, where the request may further include information (e.g., AF-ID/Provider-ID, IP Flows/AppId, QOS Reference, DNN/S-NSSAI, usageThreshold, and/or qosMonInfo) for a change/set-up of QoS. Alternatively, the request from the AF to the NEF may be a request to set a chargeable party at an AF session set-up, where the request may further include information (e.g., AF-ID/Provider-ID, IP Flows/AppId, Sponsor Information, Sponsor Status, Background Data Transfer Reference ID, and/or usageThreshold) for a change/set-up of a chargeable party.

In step 512, the NEF 400 authorizes the request from the AF 312. In addition, the NEF 400 also authorizes the AF 312 to allow to use the service. The NEF 400 may also translates the external identities to internal identities via standard UDM identity translation service, e.g., GPSI=>SUPI, external Group Identity=>internal Group Identity, and also mapping the geographic zone(s) to network tracking areas identity for example.

In step 514A/514B, the NEF 400 transmits a data update request to a unified data repository (like the UDR 404) for storage. In one embodiment, the data update request comprises information associated with the information indicating the at least one UE (associated with the UE ID for a specific UE or the UE indication for any UE) that has not established a PDU session yet. In another embodiment, the data update request from the NEF to the UDR comprises information associated with the information indicating the plurality of UEs (associated with the list of UE IDs, the UE group ID, or the UE indication for the plurality of UEs). In some embodiments, the plurality of UEs comprises at least one UE that has not established a PDU session yet.

Herein, the data update request may further comprise information associated with the one or more conditions, which define one or more geographic zones, one or more time windows, or both one or more geographic zones and one or more time windows. In addition, the data update request may further comprise QoS data (such as the QOS Reference, the IP Flows, the DNN/S-NSSAI, the usageThreshold, and/or the qosMonInfo) or sponsor data (such as the Sponsor Information, the Sponsor Status, the IP Flows, the Background Data Transfer Reference ID, and/or the usage Threshold).

In step 516, the NEF 400 receives from the UDR 404 a UDR response indicating that the data update request is stored in the UDR 404.

In step 518, the NEF 400 transmits to the AF 312 an NEF response indicating whether the request is granted or not.

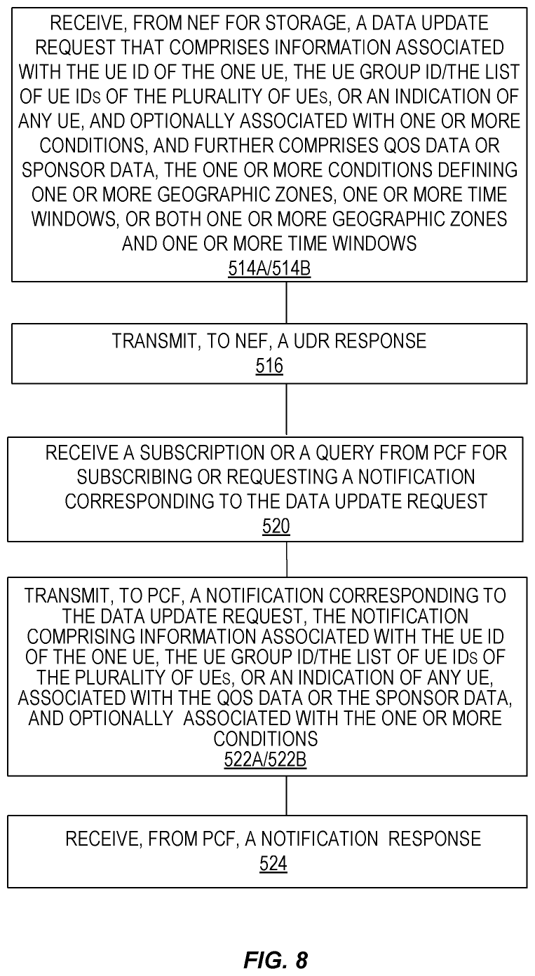

FIG. 8 is a flow chart illustrating the operation of a unified data repository (like UDR 404), in accordance with some embodiments. In step 514A/514B, the UDR 404 receives a data update request from the NEF 400 for storage. In one embodiment, the data update request comprises information associated with the information indicating the at least one UE that has not established a PDU session yet. The information indicating the at least one UE may include a UE identity (e.g., GPSI or a UE IP address) for a specific UE of the at least one UE or include a UE indication (e.g., anyUeInd) for indicating any UE of the at least one UE. In another embodiment, the data update request from the NEF to the UDR comprises information associated with the information indicating the plurality of UEs. The information indicating the plurality of UEs may include a list of UE IDs of the plurality of UEs, a UE group ID of the plurality of UEs (e.g., externalGroupId), or a UE indication (e.g., anyUeInd) for indicating any UE of the plurality of UEs. In some embodiments, the plurality of UEs comprises at least one UE that has not established a PDU session yet.

Herein, the data update request may further comprise information associated with one or more conditions to be satisfied by the at least one UE/the plurality of UEs. The one or more conditions define one or more geographic zones, one or more time windows, or both one or more geographic zones and one or more time windows. In addition, the data update request may further comprise the QoS data (such as the QOS Reference, the IP Flows, the DNN/S-NSSAI, the usage Threshold, and/or the qosMonInfo) or the sponsor data (such as the Sponsor Information, the Sponsor Status, the IP Flows, the Background Data Transfer Reference ID, and/or the usageThreshold).

In step 516, the UDR 404 transmits to the NEF 400 a UDR response indicating that the data update request is stored in the UDR 404.

In step 520, the UDR 404 receives a subscription from the PCF 310 for subscribing a notification corresponding to the data update request. The subscription may be transmitted via a Nudr_DM service. Alternatively, the UDR 404 receives a query from the PCF 310, during UE registration, for requesting the notification corresponding to the data update request.

In step 522A/522B, the UDR 404 transmits a notification to a policy control function (like the PCF 310) corresponding to the data update request. In one embodiment, the notification comprises information associated with the information indicating the at least one UE (associated with the UE ID for a specific UE or the UE indication for any UE) that has not established a PDU session yet. In another embodiment, the notification from the UDR to the PCF comprises information associated with the information indicating the plurality of UEs (associated with the list of UE IDs, the UE group ID, or the UE indication for the plurality of UEs).

Herein, the notification may further comprise information associated with the one or more conditions, which define one or more geographic zones, one or more time windows, or both one or more geographic zones and one or more time windows. In addition, the notification may further comprise information associated with the QoS data or the sponsor data, respectively.

In step 524, the UDR 404 receives from the PCF 310 a notification response indicating that the PCF 310 successfully receives the notification.

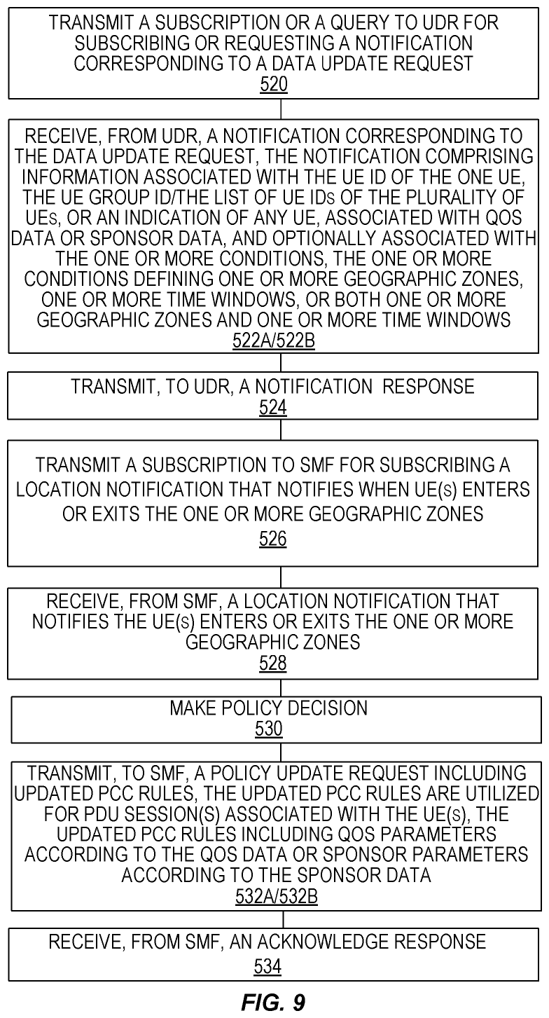

FIG. 9 is a flow chart illustrating the operation of a policy control function (like the PCF 310), in accordance with some embodiments. In step 520, the PCF 310 transmits a subscription to a unified data repository (like UDR 404) for subscribing a notification corresponding to a data update request from the NEF 400 to the UDR 404. The subscription may be transmitted via a Nudr_DM service. Alternatively, the PCF 310 transmits a query to the UDR 404, during UE registration, for requesting the notification corresponding to the data update request from the NEF 400 to the UDR 404.

In one embodiment, the data update request from the NEF 400 to the UDR 404 comprises information associated with the information indicating the at least one UE that has not established a PDU session yet. The information indicating the at least one UE may include a UE identity (e.g., GPSI or a UE IP address) for a specific UE of the at least one UE or include a UE indication (e.g., anyUeInd) indicating any UE of the at least one UE. In another embodiment, the data update request from the NEF 400 to the UDR 404 comprises information associated with the information indicating the plurality of UEs. The information indicating the plurality of UEs may include a list of UE IDs of the plurality of UEs, a UE group ID of the plurality of UEs (e.g., externalGroupId), or a UE indication (e.g., anyUeInd) indicating any UE of the plurality of UEs. In some embodiments, the plurality of UEs comprises at least one UE that has not established a PDU session yet.

Herein, the data update request from the NEF 400 to the UDR 404 may further comprise information associated with one or more conditions to be satisfied by the at least one UE/the plurality of UEs. The one or more conditions define one or more geographic zones, one or more time windows, or both one or more geographic zones and one or more time windows. In addition, the data update request from the NEF 400 to the UDR 404 may further comprise the QoS data (such as the QoS Reference, the IP Flows, the DNN/S-NSSAI, the usageThreshold, and/or the qosMonInfo), or the sponsor data (such as the Sponsor Information, the Sponsor Status, the IP Flows, the Background Data Transfer Reference ID, and/or the usage Threshold).

In step 522A/522B, the PCF 310 receives a notification from the UDR 404 corresponding to the data update request. In one embodiment, the notification comprises information associated with the information indicating the at least one UE (associated with the UE ID for a specific UE or the UE indication for any UE) that has not established a PDU session yet. In another embodiment, the notification from the UDR to the PCF comprises information associated with the information indicating the plurality of UEs (associated with the list of UE IDs, the UE group ID, or the UE indication for the plurality of UEs).

Herein, the notification may further comprise information associated with the one or more conditions, which define one or more geographic zones, one or more time windows, or both one or more geographic zones and one or more time windows. In addition, the notification may further comprise information associated with the QoS data or the sponsor data, respectively.

In step 524, the PCF 310 transmits to the UDR 404 a notification response indicating that the PCF 310 successfully receives the notification.

In step 526, the PCF 310 may transmit to a session management function (like the SMF 308) a subscription for subscribing a location notification (if the one or more geographic zones are defined in the conditions) that notifies when the at least one UE/the plurality of UEs (212) enters or exits the one or more geographic zones.

In step 528, the PCF 310 may receive from the SMF 308, a location notification (if the one or more geographic zones are defined in the conditions) that notifies the at least one UE/the plurality of UEs (212) enters or exits the one or more geographic zones.

In step 530, the PCF 310 may make a policy decision based on a location of the at least one UE/the plurality of UEs within or without the one or more geographic zones, and/or based on a current time within or without the one or more time windows (if the one or more geographic zones, and/or the one or more time windows are defined in the conditions).

In step 532A/532B, the PCF 310 transmits a policy update request to the SMF 308. The policy update request includes updated PCC rules, which are utilized for PDU session(s) associated with the at least one UE/the plurality of UEs. The updated PCC rules include QoS parameters according to the QoS data retrieved from the UDR 404, or includes sponsor parameters according to the sponsor data retrieved from the UDR 404.

In step 534, the PCF 310 receives from the SMF 308 an acknowledge response acknowledging the policy update request.

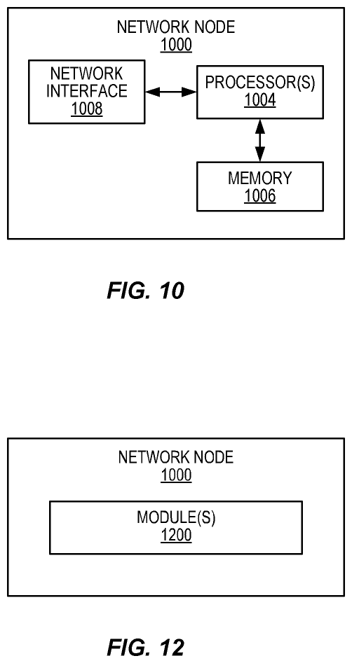

FIG. 10 is a schematic block diagram of a network node 1000 according to some embodiments of the present disclosure. Optional features are represented by dashed boxes. The network node 1000 may be, for example, a base station 202 or 206 or a network node that implements all or part of the functionality of the base station 202 or gNB described herein. As illustrated, the network node 1000 includes a control system 1002 that includes one or more processors 1004 (e.g., Central Processing Units (CPUs), Application Specific Integrated Circuits (ASICs), Field Programmable Gate Arrays (FPGAs), and/or the like), memory 1006, and a network interface 1008. The one or more processors 1004 are also referred to herein as processing circuitry. The one or more processors 1004 operate to provide one or more functions of a network node 1000 as described herein (e.g., one or more functions of the AF 312, the NEF 400, the UDR 404, or the PCF 310). In some embodiments, the function(s) are implemented in software that is stored, e.g., in the memory 1006 and executed by the one or more processors 1004.

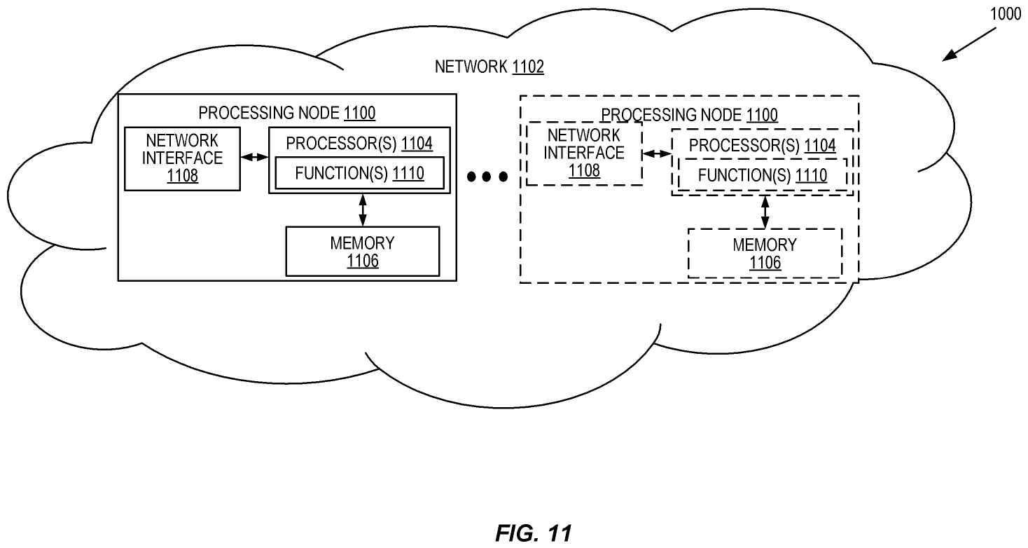

FIG. 11 is a schematic block diagram that illustrates a virtualized embodiment of the network node 1000 according to some embodiments of the present disclosure. As used herein, a “virtualized” network node is an implementation of the network node 1000 in which at least a portion of the functionality of the network node 1000 is implemented as a virtual component(s) (e.g., via a virtual machine(s) executing on a physical processing node(s) in a network(s)). As illustrated, in this example, the network node 1000 may include one or more processing nodes 1100 coupled to or included as part of a network(s) 1102. Each processing node 1100 includes one or more processors 1104 (e.g., CPUs, ASICs, FPGAs, and/or the like), memory 1106, and a network interface 1108.

In this example, functions 1110 of the network node 1000 described herein (e.g., one or more functions of the AF 312, the NEF 400, the UDR 404, or the PCF 310) are implemented at the one or more processing nodes in any desired manner. In some particular embodiments, some or all of the functions 1110 of the network node 1000 described herein are implemented as virtual components executed by one or more virtual machines implemented in a virtual environment(s) hosted by the processing node(s) 1100.

In some embodiments, a computer program including instructions which, when executed by at least one processor, causes the at least one processor to carry out the functionality of network node 1000 or a node (e.g., a processing node 1100) implementing one or more of the functions 1110 of the network node 1000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the network node 1000 according to some other embodiments of the present disclosure. The network node 1000 includes one or more modules 1200, each of which is implemented in software. The module(s) 1200 provide the functionality of the network node 1000 described herein (e.g. one or more functions of the AF 312, the NEF 400, the UDR 404, or the PCF 310). This discussion is equally applicable to the processing node 1100 of FIG. 11 where the modules 1200 may be implemented at one of the processing nodes 1100 or distributed across multiple processing nodes 1100.

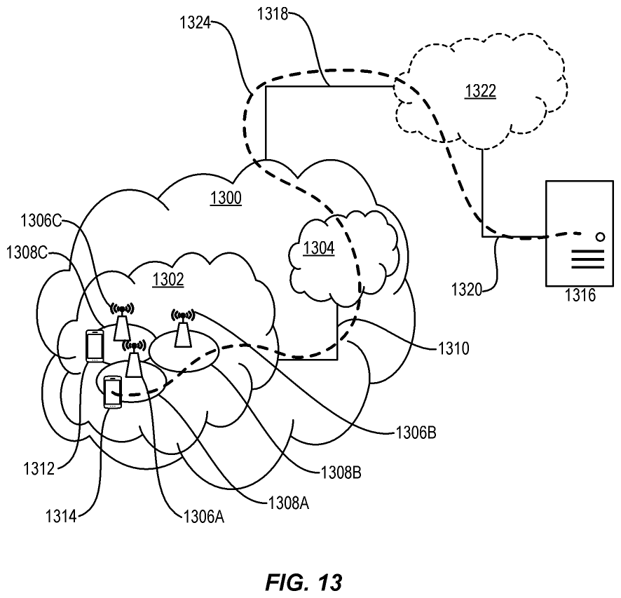

With reference to FIG. 13, in accordance with an embodiment, a communication system includes a telecommunication network 1300, such as a 3GPP-type cellular network, which comprises an access network 1302, such as a RAN, and a core network 1304. The access network 1302 comprises a plurality of base stations 1306A, 1306B, 1306C, such as Node Bs, eNBs, gNBs, or other types of wireless Access Points (APs), each defining a corresponding coverage area 1308A, 1308B, 1308C. Each base station 1306A, 1306B, 1306C is connectable to the core network 1304 over a wired or wireless connection 1310. A first UE 1312 located in coverage area 1308C is configured to wirelessly connect to, or be paged by, the corresponding base station 1306C. A second UE 1314 in coverage area 1308A is wirelessly connectable to the corresponding base station 1306A. While a plurality of UEs 1312, 1314 are illustrated in this example, the disclosed embodiments are equally applicable to a situation where a sole UE is in the coverage area or where a sole UE is connecting to the corresponding base station 1306.

The telecommunication network 1300 is itself connected to a host computer 1316, which may be embodied in the hardware and/or software of a standalone server, a cloud-implemented server, a distributed server, or as processing resources in a server farm. The host computer 1316 may be under the ownership or control of a service provider, or may be operated by the service provider or on behalf of the service provider. Connections 1318 and 1320 between the telecommunication network 1300 and the host computer 1316 may extend directly from the core network 1304 to the host computer 1316 or may go via an optional intermediate network 1322. The intermediate network 1322 may be one of, or a combination of more than one of, a public, private, or hosted network; the intermediate network 1322, if any, may be a backbone network or the Internet; in particular, the intermediate network 1322 may comprise two or more sub-networks (not shown).

The communication system of FIG. 13 as a whole enables connectivity between the connected UEs 1312, 1314 and the host computer 1316. The connectivity may be described as an Over-the-Top (OTT) connection 1324. The host computer 1316 and the connected UEs 1312, 1314 are configured to communicate data and/or signaling via the OTT connection 1324, using the access network 1302, the core network 1304, any intermediate network 1322, and possible further infrastructure (not shown) as intermediaries. The OTT connection 1324 may be transparent in the sense that the participating communication devices through which the OTT connection 1324 passes are unaware of routing of uplink and downlink communications. For example, the base station 1306 may not or need not be informed about the past routing of an incoming downlink communication with data originating from the host computer 1316 to be forwarded (e.g., handed over) to a connected UE 1312. Similarly, the base station 1306 need not be aware of the future routing of an outgoing uplink communication originating from the UE 1312 towards the host computer 1316.

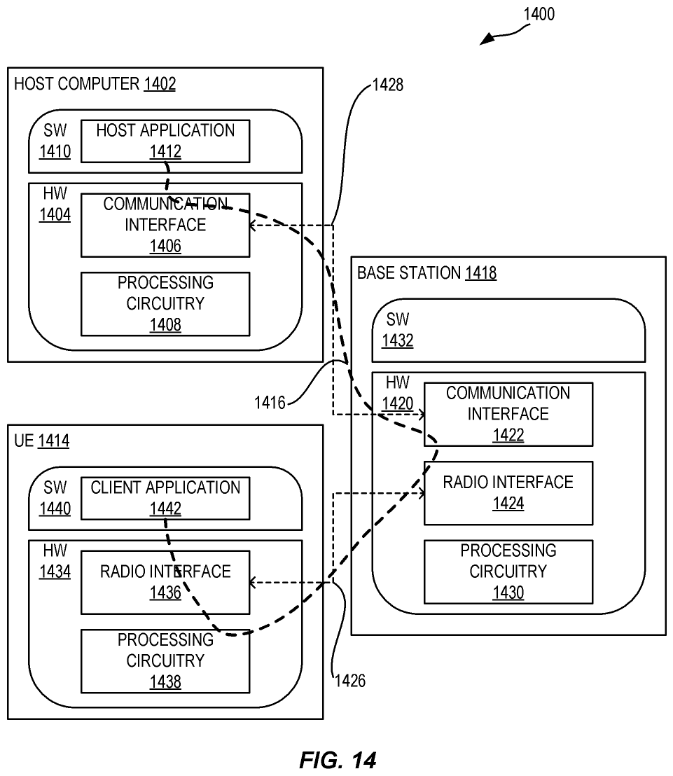

Example implementations, in accordance with an embodiment, of the UE, base station, and host computer discussed in the preceding paragraphs will now be described with reference to FIG. 14. In a communication system 1400, a host computer 1402 comprises hardware 1404 including a communication interface 1406 configured to set up and maintain a wired or wireless connection with an interface of a different communication device of the communication system 1400. The host computer 1402 further comprises processing circuitry 1408, which may have storage and/or processing capabilities. In particular, the processing circuitry 1408 may comprise one or more programmable processors, ASICs, FPGAs, or combinations of these (not shown) adapted to execute instructions. The host computer 1402 further comprises software 1410, which is stored in or accessible by the host computer 1402 and executable by the processing circuitry 1408. The software 1410 includes a host application 1412. The host application 1412 may be operable to provide a service to a remote user, such as a UE 1414 connecting via an OTT connection 1416 terminating at the UE 1414 and the host computer 1402. In providing the service to the remote user, the host application 1412 may provide user data which is transmitted using the OTT connection 1416.

The communication system 1400 further includes a base station 1418 provided in a telecommunication system and comprising hardware 1420 enabling it to communicate with the host computer 1402 and with the UE 1414. The hardware 1420 may include a communication interface 1422 for setting up and maintaining a wired or wireless connection with an interface of a different communication device of the communication system 1400, as well as a radio interface 1424 for setting up and maintaining at least a wireless connection 1426 with the UE 1414 located in a coverage area (not shown in FIG. 14) served by the base station 1418. The communication interface 1422 may be configured to facilitate a connection 1428 to the host computer 1402. The connection 1428 may be direct or it may pass through a core network (not shown in FIG. 14) of the telecommunication system and/or through one or more intermediate networks outside the telecommunication system. In the embodiment shown, the hardware 1420 of the base station 1418 further includes processing circuitry 1430, which may comprise one or more programmable processors, ASICs, FPGAs, or combinations of these (not shown) adapted to execute instructions. The base station 1418 further has software 1432 stored internally or accessible via an external connection.

The communication system 1400 further includes the UE 1414 already referred to. The UE's 1414 hardware 1434 may include a radio interface 1436 configured to set up and maintain a wireless connection 1426 with a base station serving a coverage area in which the UE 1414 is currently located. The hardware 1434 of the UE 1414 further includes processing circuitry 1438, which may comprise one or more programmable processors, ASICs, FPGAs, or combinations of these (not shown) adapted to execute instructions. The UE 1414 further comprises software 1440, which is stored in or accessible by the UE 1414 and executable by the processing circuitry 1438. The software 1440 includes a client application 1442. The client application 1442 may be operable to provide a service to a human or non-human user via the UE 1414, with the support of the host computer 1402. In the host computer 1402, the executing host application 1412 may communicate with the executing client application 1442 via the OTT connection 1416 terminating at the UE 1414 and the host computer 1402. In providing the service to the user, the client application 1442 may receive request data from the host application 1412 and provide user data in response to the request data. The OTT connection 1416 may transfer both the request data and the user data. The client application 1442 may interact with the user to generate the user data that it provides.

It is noted that the host computer 1402, the base station 1418, and the UE 1414 illustrated in FIG. 14 may be similar or identical to the host computer 1316, one of the base stations 1306A, 1306B, 1306C, and one of the UEs 1312, 1314 of FIG. 13, respectively. This is to say, the inner workings of these entities may be as shown in FIG. 14 and independently, the surrounding network topology may be that of FIG. 13.

In FIG. 14, the OTT connection 1416 has been drawn abstractly to illustrate the communication between the host computer 1402 and the UE 1414 via the base station 1418 without explicit reference to any intermediary devices and the precise routing of messages via these devices. The network infrastructure may determine the routing, which may be configured to hide from the UE 1414 or from the service provider operating the host computer 1402, or both. While the OTT connection 1416 is active, the network infrastructure may further take decisions by which it dynamically changes the routing (e.g., on the basis of load balancing consideration or reconfiguration of the network).

The wireless connection 1426 between the UE 1414 and the base station 1418 is in accordance with the teachings of the embodiments described throughout this disclosure. One or more of the various embodiments improve the performance of OTT services provided to the UE 1414 using the OTT connection 1416, in which the wireless connection 1426 forms the last segment.

A measurement procedure may be provided for the purpose of monitoring data rate, latency, and other factors on which the one or more embodiments improve. There may further be an optional network functionality for reconfiguring the OTT connection 1416 between the host computer 1402 and the UE 1414, in response to variations in the measurement results. The measurement procedure and/or the network functionality for reconfiguring the OTT connection 1416 may be implemented in the software 1410 and the hardware 1404 of the host computer 1402 or in the software 1440 and the hardware 1434 of the UE 1414, or both. In some embodiments, sensors (not shown) may be deployed in or in association with communication devices through which the OTT connection 1416 passes; the sensors may participate in the measurement procedure by supplying values of the monitored quantities exemplified above, or supplying values of other physical quantities from which the software 1410, 1440 may compute or estimate the monitored quantities. The reconfiguring of the OTT connection 1416 may include message format, retransmission settings, preferred routing, etc.; the reconfiguring need not affect the base station 1418, and it may be unknown or imperceptible to the base station 1418. Such procedures and functionalities may be known and practiced in the art. In certain embodiments, measurements may involve proprietary UE signaling facilitating the host computer's 1402 measurements of throughput, propagation times, latency, and the like. The measurements may be implemented in that the software 1410 and 1440 causes messages to be transmitted, in particular empty or ‘dummy’ messages, using the OTT connection 1416 while it monitors propagation times, errors, etc.

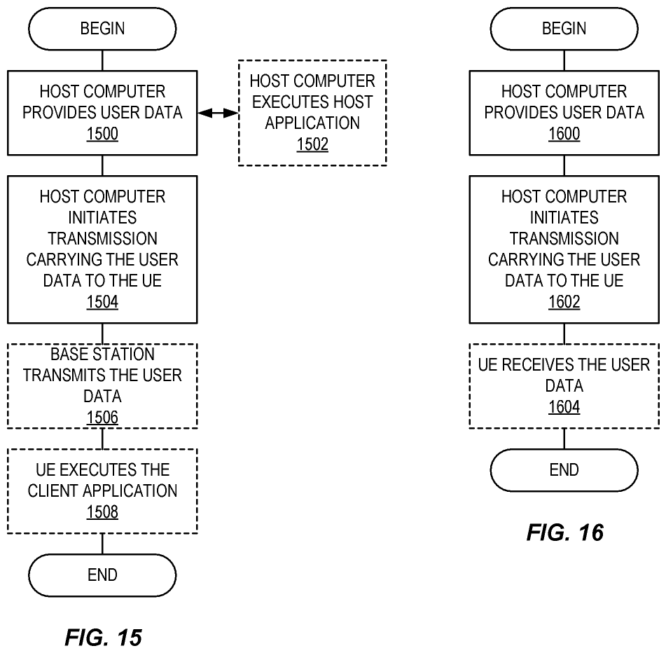

FIG. 15 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 15 will be included in this section. In step 1500, the host computer provides user data. In sub-step 1502 (which may be optional) of step 1500, the host computer provides the user data by executing a host application. In step 1504, the host computer initiates a transmission carrying the user data to the UE. In step 1506 (which may be optional), the base station transmits to the UE the user data which was carried in the transmission that the host computer initiated, in accordance with the teachings of the embodiments described throughout this disclosure. In step 1508 (which may also be optional), the UE executes a client application associated with the host application executed by the host computer.

FIG. 16 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 16 will be included in this section. In step 1600 of the method, the host computer provides user data. In an optional sub-step (not shown) the host computer provides the user data by executing a host application. In step 1602, the host computer initiates a transmission carrying the user data to the UE. The transmission may pass via the base station, in accordance with the teachings of the embodiments described throughout this disclosure. In step 1604 (which may be optional), the UE receives the user data carried in the transmission.

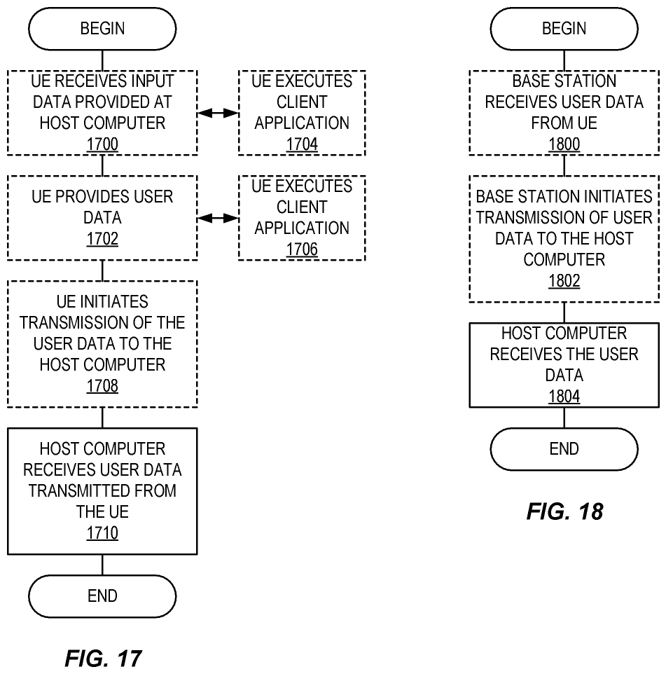

FIG. 17 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 17 will be included in this section. In step 1700 (which may be optional), the UE receives input data provided by the host computer. Additionally or alternatively, in step 1702, the UE provides user data. In sub-step 1704 (which may be optional) of step 1700, the UE provides the user data by executing a client application. In sub-step 1706 (which may be optional) of step 1702, the UE executes a client application which provides the user data in reaction to the received input data provided by the host computer. In providing the user data, the executed client application may further consider user input received from the user. Regardless of the specific manner in which the user data was provided, the UE initiates, in sub-step 1708 (which may be optional), transmission of the user data to the host computer. In step 1710 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 18 will be included in this section. In step 1800 (which may be optional), in accordance with the teachings of the embodiments described throughout this disclosure, the base station receives user data from the UE. In step 1802 (which may be optional), the base station initiates transmission of the received user data to the host computer. In step 1804 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
API Application Programming Interface
AS Application Server
ASIC Application Specific Integrated Circuit
AUSF Authentication Server Function
CP Control Plane
CPU Central Processing Unit
DCI Downlink Control Information
DL Downlink
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MAC Medium Access Control
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
PCRF Policy and Charging Rule Function
PDSCH Physical Downlink Shared Channel
PDU Protocol Data Unit
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SMF Session Management Function
TCI Transmission Configuration Indicator
TRP Transmission/Reception Point
UDR Unified Data Repository
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1-149. (canceled)

150. A method of operation of a Network Exposure Function, NEF, the method comprising:
receiving a request from an Application Function, AF, wherein the request comprises information indicating a plurality of UEs; and
transmitting, to the AF, an NEF response indicating whether the request is granted or not.

151. The method of claim 150, wherein the plurality of UEs comprises at least one UE that has not established a Protocol Data Unit, PDU, session yet.

152. The method of claim 150, wherein the information indicating the plurality of UEs comprises a list of UE IDs of the plurality of UEs, a UE group ID of the plurality of UEs, or a UE indication that identifies whether the request applies to any UE of the plurality of UEs.

153. The method of claim 152, further comprising:
transmitting data update request to a Unified Data Repository, UDR, for storage, wherein the data update request comprises information associated with the list of UE IDs, the UE group ID, or the UE indication; and
receiving, from the UDR, a UDR response indicating that the data update request is stored in the UDR.

154. The method of claim 153, wherein:
the request further comprises one or more conditions to be satisfied by the plurality of UEs; and
the data update request further comprises information associated with the one or more conditions.

155. The method of claim 154, wherein the one or more conditions define one or more geographic zones, one or more time windows, or both one or more geographic zones and one or more time windows.

156. The method of claim 153, wherein the data update request further comprises QoS data or sponsor data.

157. A network node that implements a Network Exposure Function, NEF, the network node comprising:
a network interface; and
processing circuitry associated with the network interface, the processing circuitry configured to cause the network node to:
receive a request from an Application Function, AF, wherein the request comprises information indicating a plurality of UEs; and
transmit, to the AF, an NEF response indicating whether the request is granted or not.

158. The network node of claim 157, wherein the plurality of UEs comprises at least one UE that has not established a Protocol Data Unit, PDU, session yet.

159. The network node of claim 157, wherein the information indicating the plurality of UEs comprises a list of UE IDs of the plurality of UEs, a UE group ID of the plurality of UEs, or a UE indication that identifies whether the request applies to any UE of the plurality of UEs.

160. The network node of claim 159, wherein the processing circuitry is further configured to cause the network node to:
transmit data update request to a Unified Data Repository, UDR, for storage, wherein the data update request comprises information associated with the list of UE IDs, the UE group ID, or the UE indication; and
receive, from the UDR, a UDR response indicating that the data update request is stored in the UDR.

161. The network node of claim 160, wherein:
the request further comprises one or more conditions to be satisfied by the plurality of UEs; and
the data update request further comprises information associated with the one or more conditions.

162. The network node of claim 161, wherein the one or more conditions define one or more geographic zones, one or more time windows, or both one or more geographic zones and one or more time windows.

163. The network node of claim 160, wherein the data update request further comprises QoS data or sponsor data.

164. A method of operation of a Policy Control Function, PCF, the method comprising:
receiving, from a Unified Data Repository, UDR, a notification corresponding to a data update request, wherein the notification comprises information associated with information indicating a plurality of UEs; and
transmitting, to the UDR, a notification response indicating that the PCF successfully receives the notification.

165. The method of claim 164, wherein the plurality of UEs comprises at least one UE that has not established a Protocol Data Unit, PDU, session yet.

166. The method of claim 164, wherein the information indicating the plurality of UEs is information associated with a list of UE IDs of the plurality of UEs, a UE group ID of the plurality of UEs, or a UE indication that indicates any UE of the plurality of UEs.

167. The method of claim 166, wherein the notification further comprises information associated with QoS data or sponsor data.

168. The method of claim 166, wherein the notification further comprises information associated with one or more conditions to be satisfied by the plurality of UEs.

169. The method of claim 168, wherein the one or more conditions define one or more geographic zones, one or more time windows, or both one or more geographic zones and one or more time windows.

170. The method of claim 169, further comprising:
transmitting, to a Session Management Function, SMF, a subscription for subscribing a location notification that notifies when the plurality of UEs enters or exits the one or more geographic zones, wherein the one or more conditions at least defines the one or more geographic zones.

171. The method of claim 170, further comprising:
receiving, from the SMF, the location notification when the plurality of UEs enters or exits the one or more geographic zones.

172. The method of claim 171, further comprising:
making a policy decision based on the location of the plurality of UEs within or without the one or more geographic zones, and/or based on a current time within or without the one or more time windows.

173. The method of claim 172, further comprising:
based on the policy decision, transmitting a policy update request including updated policy and charging control, PCC, rules to the SMF, wherein the updated PCC rules are utilized for PDU sessions associated with the plurality of UEs; and
receiving, from the SMF, an acknowledge response acknowledging the policy update request.

174. The method of claim 173, wherein the updated PCC rules include QoS parameters according to the QoS data retrieved from the UDR or include sponsor parameters according to the sponsor data retrieved from the UDR.

175. The method of claim 164, before receiving the notification, further comprising:
transmitting a subscription to the UDR for subscribing the notification corresponding to the data update request; or
transmitting a query to the UDR, during UE registration, for requesting the notification corresponding to the data update request.
